(19) United States
(12) Patent Application Publication
(10) Pub. No.: US 2004/0260626 A1
(43) Pub. Date: Dec. 23, 2004

(54) Rental price indexing and inventory control method and system

(75) Inventors: Huntly Christie, Orlando, FL (US); Paul Dhingra, Mississauga (CA)

Correspondence Address: Mark B. Eisen, Dimock Stratton Clarizio LLP, 20 Queen Street West, Suite 3202, Box 102, Toronto, ON, M5H 3R3, CA

(73) Assignee: CHRISTIE LITES LTD.

(21) Appl. No.: 10/464,844

(22) Filed: Jun. 19, 2003

(51) Int. Cl. G06F 17/60

(52) U.S. Cl. 705/28

(57) ABSTRACT

A method for organizing and controlling rental inventory provides an alphanumeric code for each principal item, and based thereon an alphanumeric code for each accessory item that may be used with the principal item. Each accessory applicable to more than one principal item is also provided with a unique alias code that identifies the accessory item without reference to its associated principal items. A Base Price is assigned to each principal item and each accessory item, based on a number of factors which can be independently determined for each rental item. The Base Price is multiplied by a Price Factor derived from a Price Index Table according to the desired rental interval, to generate the Price Index for the item. This creates a standard for determining rental prices, and provides a standardized means of measuring many different types of performance in a rental business.

### FIELD OF INVENTION

The present invention relates to a price indexing and inventory control system for a product rental business. In particular, the invention relates to a code structure for organizing and controlling the flow of rental inventory, and a price indexing system for determining rental prices on a standardized basis.

### BACKGROUND OF THE INVENTION

A product rental business poses many challenges. Two problems are encountered in any product rental business: first, how to organize and control the rental inventory; and second, how to determine rental prices in a logical, consistent manner which enables the business to recoup its initial investment in the inventory, make a suitable profit, and evaluate the residual value of inventory (for example, for accounting or replacement purposes) at any particular point in time.

Many rental businesses rely on arbitrary inventory code assignments and manual tracking procedures to facilitate inventory organization, and make ad hoc determinations of rental pricing based on historical information and/or competitors' pricing in order to maximize profits. These systems, although not ideal, are workable within a limited rental business environment. However, once the rental inventory becomes too large, manual tracking and arbitrary coding become more inefficient, in some cases to the point of being impractical. This is especially the case in a rental business where some inventory items are related to other inventory items and are thus often (but not always) rented together, or where there can be many different combinations and permutations of principal items rented with accessories.

For example, in the rental of lighting equipment for the stage and theatre industries, there are myriad types of lights and associated equipment which are maintained in inventory to accommodate the diverse requirements of different types of productions. These lights and associated equipment can be rented with a large variety of accessories including different types of stands, filters, reflectors, power supplies, control consoles and so on. Each inventory item must have a rental price assigned to it which is not only acceptable to the marketplace, but also accommodates the initial cost of the item, carrying costs, overhead, repairs and other costs, in a way that maximizes the probability that over the rentable life of the rental item a profit will be generated. It would accordingly be advantageous to have a standardized price indexing system for determining rental prices. Further, it would be advantageous to provide a system and method by which each rented item and item in inventory can be readily identified, enabling the rental business to quickly and easily determine what items remain in inventory, which items in inventory have been reserved for a customer, when items are being returned to inventory, and whether there are sufficient accessories in inventory to support the rental of specific principal inventory items.

Measuring performance in a rental business can also be a considerable challenge. In the context of product sales, performance can be determined by comparing the amount paid when purchasing a product with the amount received when selling the product, and various other direct costs such as overhead. This involves a simple mathematical calculation based on readily determinable quantities. In the context of product rentals, however, measuring performance is much more difficult. In order to understand how much is paid for a product over the rentable life of the product, many factors characteristic of the item, which are not necessarily direct costs, must be taken into account.

It would therefore be further advantageous to have a means of determining rental prices for various items that provides a useful indication of performance of various aspects of the rental business. This not only helps to ensure that each rental item generates a profit over its useful life, but also provides valuable historical data against which many types of performance (e.g. product, rental location, rental account personnel etc.) can be measured to facilitate the making of business decisions.

### SUMMARY OF THE INVENTION

The present invention accordingly provides a method of organizing and controlling a rental inventory, and a pricing system for determining rental prices for the rental inventory and for measuring performance of various aspects of the rental business.

The invention accomplishes this by providing an alphanumeric code for each principal item, and based thereon an alphanumeric code for each accessory item that can be used with the principal item. To avoid duplication when checking inventory or product availability, each accessory applicable to more than one principal item is also provided with a unique alias code that identifies the particular accessory without reference to its associated principal items.

The coding system of the invention allows users to easily locate and select an inventory item based on the type of product, and in the preferred embodiment other characteristics of each particular product type such as the number of channels of a console, the type or wattage of a light bulb, etc. The preferred coding system allows for easy browsing of the rental product list, in that similar product types appear close to each other alphabetically, and allows accessories to be listed under each product with which they are normally associated. Thus, accessory items that apply to more than one principal product appear in multiple places in the inventory list, to thereby be visibly associated with all potentially applicable principal items, while maintaining a distinctive identification as an independent item through an alias code.

Also, according to the invention a Base Price is generated for each principal item and each accessory item, based on a number of factors which can be independently determined for each rental item. The Base Price is multiplied by a Price Factor derived from a Price Index Table, according to the desired rental interval, to generate the Price Index for the item. This creates a standard for determining rental prices, and provides a standardized means of measuring many different types of performance in the rental business.

The present invention thus provides a method of controlling a rental item inventory, comprising the steps of: a. assigning a unique alphanumeric code to each of a plurality of principal items in the rental item inventory, comprising an alphabetic prefix followed by an alphanumeric suffix, b. assigning a unique alphanumeric code to at least one accessory item associated with the principal item in the rental item inventory, comprising the alphabetic prefix of the principal item and a truncation of the alphanumeric suffix of the principal item, and at least one alphanumeric character for distinguishing the accessory item from other accessory items associated with the principal item, and c. assigning a unique alphanumeric alias code to the accessory item, whereby the accessory item is provided a unique alias code for identifying the accessory item and different unique alphanumeric codes associating the accessory item with each of a plurality of different principal items.

The present invention further provides a system for controlling a rental item inventory, comprising: means for assigning a unique alphanumeric code to each of a plurality of principal items in the rental item inventory, comprising an alphabetic prefix followed by an alphanumeric suffix, means for assigning a unique alphanumeric code to at least one accessory item associated with the principal item in the rental item inventory, comprising the alphabetic prefix of the principal item and a truncation of the alphanumeric suffix of the principal item, and at least one alphanumeric character for distinguishing the accessory item from other accessory items associated with the principal item, and means for assigning a unique alphanumeric alias code to the accessory item, whereby the accessory item is provided a unique alias code for identifying the accessory item and different unique alphanumeric codes associating the accessory item with each of a plurality of different principal items.

The present invention further provides a computer program product for use with a computer, the computer program product comprising a computer usable medium having computer readable program code means embodied in said medium for generating a model of a computer program having program code designed to implement specified requirements comprising a series of conditions, each condition having a position designation, and one or more significant positions which are positions defining a segments of the model which can be analyzed, and having added as an input to each transition immediately following a significant position a redundant position having no input transition, the state of which controls activation of its output transition, said computer program product having a. computer readable program code means for associating a unique alphanumeric code with each of a plurality of principal items in the rental item inventory, comprising an alphabetic prefix followed by an alphanumeric suffix, b. computer readable program code means for associating a unique alphanumeric code with at least one accessory item associated with the principal item in the rental item inventory, comprising the alphabetic prefix of the principal item and a truncation of the alphanumeric suffix of the principal item, and at least one alphanumeric character for distinguishing the accessory item from other accessory items associated with the principal item, and c. computer readable program code means for associating a unique alphanumeric alias code with the accessory item, whereby the accessory item is provided a unique alias code for identifying the accessory item and different unique alphanumeric codes associating the accessory item with each of a plurality of different principal items.

### BRIEF DESCRIPTION OF THE DRAWINGS

In drawings which illustrate by way of example only a preferred embodiment of the invention,

FIG. 1 is an example of a Price Factor table according to the invention, and

FIG. 2 is an example of a Price Index table, based on the Price Factor table of FIG. 1.

### DETAILED DESCRIPTION OF THE INVENTION

An example of a rental price indexing and inventory control system of the invention will be described with reference to a lighting equipment rental business. It will be appreciated by those skilled in the art that the principles of the invention can be applied to other rental products.

Coding the Principal Item

Each item of rental inventory is assigned an alphanumeric item code. In the preferred embodiment the item code consists of seven alphanumeric characters. The first three characters are preferably an alphabetic truncation or abbreviation of the common name of the item, so for example the prefix of all console codes is ‘CON’, while ‘MOV’ is the prefix used for moving lights, ‘TRU’ for trusses, ‘BUL’ for bulbs, etc. This allows personnel to quickly identify the category of rental item. The three letter truncation is then followed by one or more numeric characteristics of the item, for example the number of channels of a console, the type or wattage of a light bulb, and so on.

Taking for example consoles, which are control boards used to control the behavior of other types of lighting equipment (moving lights, conventional lights, colour changers, etc), each console can transmit a certain number of channels of data which are picked up by the various lights connected to the network. In this case the ‘CON’ prefix is followed by the number of channels the console supports, which is a characteristic of the product category that is readily identifiable and serves to distinguish item types within the category. Other item categories use different factors for the numeric code following the three letter prefix.

Coding Accessories

Appearing after the principal item in the alphabetical browse list is a list of associated accessories, with the last character of the numeric portion of the code of the principal item replaced by an incremental alphabetic identifier. Thus, a section of the gear list for a 2048 channel console as the principal item is:

CON2048-2048 Channel Console

CON204A-2048 Channel Console Manual (1)

CON204B-2048 Channel Console Cover (1)

CON204E-2048 Channel Console SVGA 15″ Monitor (2)

In the browse list the accessories are preferably indented so that they can be easily identified as accessories associated with a principal item. Each principal item contains a list of accessories with recommended quantities, so that when a principal item is selected the user can choose to automatically include the appropriate number of accessories. For example, when choosing the 2048 Channel Console and accessories from the list above, one manual, one cover and two monitors are selected as the recommended quantity for the particular principle item.

Linking Accessories

Another aspect of the preferred embodiment of the invention is the accessory alias. For example, video monitors are included with many different products. The same monitor in inventory is thus listed under many principal items, and since the accessories are coded based on the coding of the principal item with which it is associated, a single monitor (or any other accessory) may have many different codes. However, when checking inventory and the availability of an item, it is deceptive to consider the differently coded monitor accessory items as different items, because all of the accessory codes relate to one specific monitor in inventory. It is therefore desirable to be able to link all of the accessory codes relating to a particular item in a way which identifies the item as a single inventory item.

To accomplish this, each accessory that appears more than once in the browse list can be assigned an alias code, which appears every time the particular accessory is listed under a different principal item. For example, the alias for the monitor referred to above, which is listed along with several other codes such as those for various types (number of channels) in the category “consoles” (e.g. CON019E, CON051E, CON080E, etc), might be the unique alphanumeric code CON012E (this alias is unique as long as there is no primary item having a code that starts with CON012). Alternatively, the alias code for the monitor could be MON017, or otherwise as would readily indicate, for example, a 17 inch monitor.

When a user browses the list of products, the alphanumeric nature of the codes puts them in order as follows:

Item Category 1

Principal Item 1.1

Accessory 1.1(a)

Accessory 1.1(b)

Accessory 1.1(c)(*)

Principal Item 1.2

Accessory 1.2(a)

Accessory 1.2(b)(*)

Item Category 2

Principal Item 2.1

Accessory 2.1(a)

Accessory 2.1(b)(*)

and so on. There may be more than one principle item with the same principal item code, and this is identified numerically in the inventory database. The accessory item codes marked with an asterisk (*) above are aliases, so that when checking inventory or the availability of any one particular accessory, the quantities returned are based on a count of the number of items in inventory under each alias, and not on the accessory codes based on the principal items.

Generating a Price Index

According to the invention, a price index is created to establish a benchmark for performance. In order to understand how much is paid for a product over the rentable life of the product, many factors characteristic of the item must be taken into account, including purchase price, capital depreciation, market value, cost of capital (i.e. the ratio of profit to capital), preparation costs, expected maintenance costs, expected operation costs, and anticipated usage. Each of these factors is assigned a value based on known quantities and historical values for like items, and these factors are then combined to generate a Base Price, which is typically higher than the replacement cost of the item.

The Base Price comprises two categories of costs—initial costs, typically incurred before the item is first rented out; and recurring costs, which may be looked at by time interval, for example annually. Initial Costs include such things as purchase price, conversion or modification costs (where a purchased item has to be adapted to use in the particular rental environment, for example to work with other rental products), regulatory approval, etc. Recurring Costs include for example annual licensing fees, maintenance and repair, cleaning etc. Some Recurring Costs may be incurred whenever an item is returned after a rental, in which case a projection is made through the selected time interval (for example, if an item is expected to be rented out four times each year, the per-use cleaning cost is multiplied by four to get the annual cleaning cost).

The Base Price is preferably calculated based on a fixed time interval of Recurring Costs, rather than over the life of the item. In the preferred embodiment the Base Price is the sum of the Initial Costs plus Recurring Costs over the first year of the rental life of the item.

The next factor to consider is the estimated rentable life of the product, i.e. the length of time that the item will generate a return on the investment represented by the Base Price. Each particular item is associated with a specific Price Curve based on the rentable life of the item. For example, in the case of lighting equipment the Price Curves may be based on expected rentable life terms of 5 months, 6 months, 1 year, 1.5 years, 2 years, 2.5 years, 3 years, 3.5 years, 4 years, 5 Years. The Price Factor is preferably non-linear, taking into account the lower cost of longer rentals (due to a reduced number of per-use costs over the rentable life of the item) and ongoing annual costs. The particular formula used to generate the Price Factor, if any, is a matter of selection.

Preferably, in order to ‘reward’ longer term rentals, the price curve is not linear. Rather than dividing the full year price by the rental term to arrive at the particular term's rate, a ‘curve’ is applied so that short term rental prices are higher per unit of time than longer term rental prices, so that longer term rentals to go higher at successively lower rates (and may eventually become lower than a linear figure). This accounts for the additional overhead incurred during shorter-term rentals. Also, as is the case with many purchasing situations, preferably the greater the quantity purchased, the better the available discount. Accordingly, a client who consumes the greatest amount of rental time gets the best price. This is reflected in the price curves as every additional unit of time becomes less expensive to the client.

For example, a one year curve is preferably used for products with an estimated rental life of one year. Assuming that such a product is rented once, for a full year, at some point during that year the initial investment for that product will have been recovered, and at the end of the year a desired profit will have been realized.

In the preferred embodiment there is a single price curve, portions of which are used across all selected time periods (two year, three year, etc.) and expanded to fit the selected time frame. Essentially, the two year curve is the first half of the one year curve; the three year curve is the first one-third of the one year curve, and so on. The Price Factors are expanded to fit the time frame, and the remaining ‘holes’ are filled in with the appropriate Price Factor.

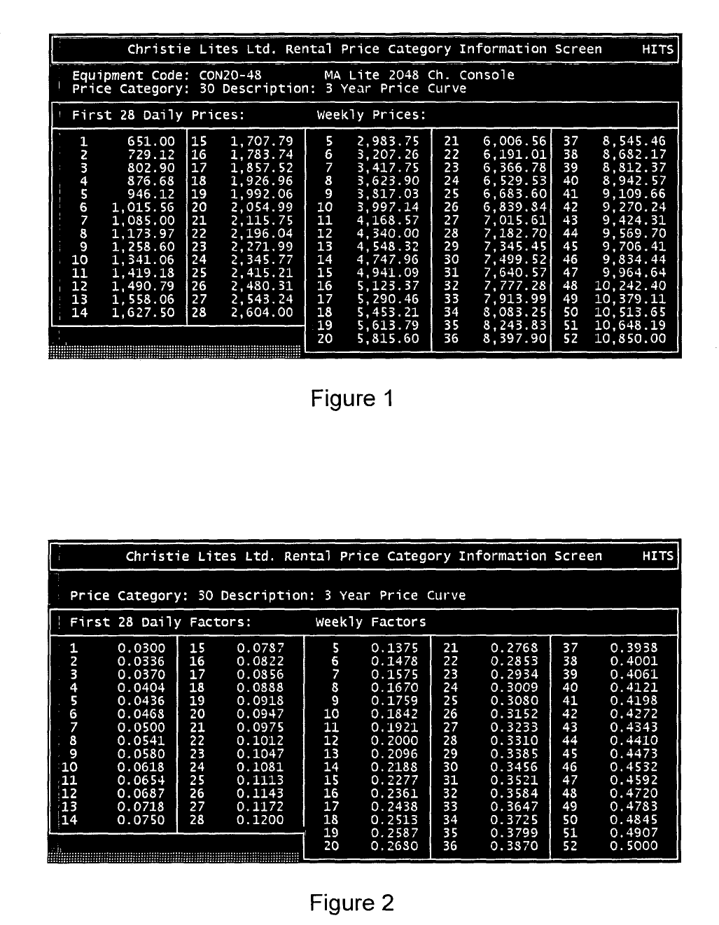

In the preferred embodiment each price curve lists a Price Factor for each of the first 28 days, and thereafter for each week of a full year from week 5 to week 52. FIG. 1 illustrates a Price Factor table over 52 weeks, by way of example. It will be appreciated that the Price Factor may be listed by month instead of by week, or any other desired time intervals, and may extend beyond 1 year as may be appropriate for any particular industry or product category.

Using the console mentioned above as an example, the Replacement Cost of this product as determined by marketplace data might be $15,500. After accounting for the remaining characteristic factors, the base price might been determined to be $21,700, with an expected return on investment (ROI) term of 3 years. If this product were rented to a client for 2 weeks, the rental cost would be determined by examining the 3 Year Price Curve in the example shown in FIG. 1, under the 14-day field, which indicates (in this example) a Price Factor of 0.0750. The Price Factor is then multiplied by the Base Price (0.0750×$21,700) to generate a Price Index of $1,627.50 for a two week rental of the item, as shown in FIG. 2.

A Total Index Price for each rental order is calculated by summing the Index Price for each principal item and all accessories rented with each principal item. The Total Index Price becomes the ‘default’ price for the order, but this can then be adjusted to accommodate other factors such as volume discounts and the like. Where, for example because of a special relationship with a client, a Rental Account Manager decides to give the client a 10% discount, the order (including each product on the order) is considered to have a Performance Against Index rating of “10% below index.” On the other hand, if because of market conditions an Account Manager were able to rent the equipment out for 20% above the Index Price, the Performance Against Index rating would be “20% above index.”

Using this system, each item's Performance Against Index percentage can be compared, even though the items have different ROI terms. This results in a Harmonized Benchmark across all of the various types of products carried by the rental company, and across all of its staff and locations.

The index data returned by this system can be compiled over time and used to measure many different types of performance, for example Account Manager Performance (which may be used for example to calculate commission and/or assess advancement capabilities), Location Performance (which may be used to compare varying market conditions in disparate geographic areas, and/or calculate royalties), Product Performance (which may be used to decide on product lines to be eliminated or adopted), and many other issues relating directly to the profitability of the rental business.

A preferred embodiment of the invention has been described by way of non-limiting example only. Those skilled in the art will appreciate that certain modifications and adaptations may be made without departing from the scope of the invention as claimed.

We claim:

1. A method of controlling a rental item inventory, comprising the steps of:
a. assigning a unique alphanumeric code to each of a plurality of principal items in the rental item inventory, comprising an alphabetic prefix followed by an alphanumeric suffix,
b. assigning a unique alphanumeric code to at least one accessory item associated with the principal item in the rental item inventory, comprising the alphabetic prefix of the principal item and a truncation of the alphanumeric suffix of the principal item, and at least one alphanumeric character for distinguishing the accessory item from other accessory items associated with the principal item, and
c. assigning a unique alphanumeric alias code to the accessory item,
whereby the accessory item is provided a unique alias code for identifying the accessory item and different unique alphanumeric codes associating the accessory item with each of a plurality of different principal items.

2. A system for controlling a rental item inventory, comprising:
means for assigning a unique alphanumeric code to each of a plurality of principal items in the rental item inventory, comprising an alphabetic prefix followed by an alphanumeric suffix,
means for assigning a unique alphanumeric code to at least one accessory item associated with the principal item in the rental item inventory, comprising the alphabetic prefix of the principal item and a truncation of the alphanumeric suffix of the principal item, and at least one alphanumeric character for distinguishing the accessory item from other accessory items associated with the principal item, and
means for assigning a unique alphanumeric alias code to the accessory item,
whereby the accessory item is provided a unique alias code for identifying the accessory item and different unique alphanumeric codes associating the accessory item with each of a plurality of different principal items.

3. A computer program product for use with a computer, the computer program product comprising a computer usable medium having computer readable program code means embodied in said medium for generating a model of a computer program having program code designed to implement specified requirements comprising a series of conditions, each condition having a position designation, and one or more significant positions which are positions defining a segments of the model which can be analyzed, and having added as an input to each transition immediately following a significant position a redundant position having no input transition, the state of which controls activation of its output transition, said computer program product having
a. computer readable program code means for associating a unique alphanumeric code with each of a plurality of principal items in the rental item inventory, comprising an alphabetic prefix followed by an alphanumeric suffix,
b. computer readable program code means for associating a unique alphanumeric code with at least one accessory item associated with the principal item in the rental item inventory, comprising the alphabetic prefix of the principal item and a truncation of the alphanumeric suffix of the principal item, and at least one alphanumeric character for distinguishing the accessory item from other accessory items associated with the principal item, and
c. computer readable program code means for associating a unique alphanumeric alias code with the accessory item,
whereby the accessory item is provided a unique alias code for identifying the accessory item and different unique alphanumeric codes associating the accessory item with each of a plurality of different principal items.
